(19) United States
(12) Patent Application Publication
(10) Pub. No.: US 2026/0301268 A1
(43) Pub. Date: Oct. 1, 2026

(54) STORAGE MEDIUM, IMAGE GENERATION SUPPORTING DEVICE, AND IMAGE GENERATION SUPPORTING METHOD

(71) Applicant: Konica Minolta, Inc., Tokyo (JP)

(72) Inventor: Tatsuji Shimizu, Sagamihara-shi (JP)

(73) Assignee: Konica Minolta, Inc., Tokyo (JP)

(21) Appl. No.: 19/577,384

(22) Filed: Mar. 25, 2026

(30) Foreign Application Priority Data
Mar. 31, 2025 (JP) 2025-057652

(51) Int. Cl. G06T 11/60

(52) U.S. Cl. CPC G06T 11/60

(57) ABSTRACT

A non-transitory computer readable storage medium storing a program that causes a hardware processor of a computer to perform, acquiring reference image data; and generating a prompt that causes a generation AI to generate an image based on an aspect ratio of the reference image data.

### CROSS-REFERENCE TO RELATED APPLICATION

The entire disclosure of Japanese Patent Application No. 2025-057652, filed on Mar. 31, 2025, including description, claims, drawings and abstract is incorporated herein by reference.

### BACKGROUND OF THE INVENTION

### TECHNICAL FIELD

The present disclosure relates to a storage medium, an image generation supporting device, and an image generation supporting method.

### DESCRIPTION OF RELATED ART

Conventionally, designs of various media such as posters, catalogs, presentation data, postcards, leaflets, and advertisements have been created. In a creation of the design, first, a salesperson of a printing company creates a draft (rough image) by drawing a request of a client while considering an aspect ratio according to a medium, and delivers the draft to a designer. The designer then completes a formal image based on the draft.

In such a flow, there is a problem that it takes a long time for the salesperson of the printing company to create the desired draft from a blank sheet state. Furthermore, the draft created by the salesperson of the printing company is not always preferable in terms of design.

On the other hand, in recent years, it has been known to generate the image from text data using generation artificial intelligence (AI).

In addition, as described in Japanese Unexamined Patent Publication No. 2005-102127, it is known to resize and clip the image to a size and the aspect ratio corresponding to a template for each medium.

It is difficult for a user who is a general user unfamiliar with the usage of the generation AI to generate the desired draft using only the text data. In particular, it is difficult and troublesome for the general user to instruct the generation AI to have an arbitrary aspect ratio.

Further, since Japanese Unexamined Patent Publication No. 2005-102127 does not generate a new image, such a problem cannot be solved.

### SUMMARY OF THE INVENTION

Therefore, it is an object of the present disclosure to increase efficiency of image generation at any aspect ratio.

In order to solve the aforementioned problem, according to one aspect of the present disclosure, a storage medium according to an aspect of the present disclosure is a non-transitory computer readable storage medium storing a program that causes a hardware processor of a computer to perform,
acquiring reference image data; and
generating a prompt that causes a generation AI to generate an image based on an aspect ratio of the reference image data.

According to another aspect of the present disclosure, an image generation supporting device including:
a hardware processor,
wherein the hardware processor is configured to perform,
acquiring reference image data, and
generating a prompt that causes a generation AI to generate an image based on an aspect ratio of the reference image data.

According to another aspect of the present disclosure, an image generation supporting method executed by an image generation supporting system, the method including:
acquiring reference image data;
generating a prompt that causes a generation AI to generate an image based on an aspect ratio of the reference image data; and
generating the image based on the generated prompt.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a block diagram illustrating a configuration of an image generation supporting system;

FIG. 2 is a flowchart illustrating an image generation supporting process;

FIG. 3 is a conceptual diagram illustrating an image generation supporting screen;

FIG. 4 is a conceptual diagram of a reference image and a generated image; and

FIG. 5 is a conceptual diagram of the reference image and the generated image.

### DETAILED DESCRIPTION

Hereinafter, one or more embodiments of the present disclosure will be described with reference to the drawings. However, the scope of the invention is not limited to the disclosed embodiments.

Hereinafter, embodiments of the present disclosure will be described with reference to the drawings. However, the scope of the present disclosure is not limited to the following embodiment and drawings.

### Image Generation Supporting System 100

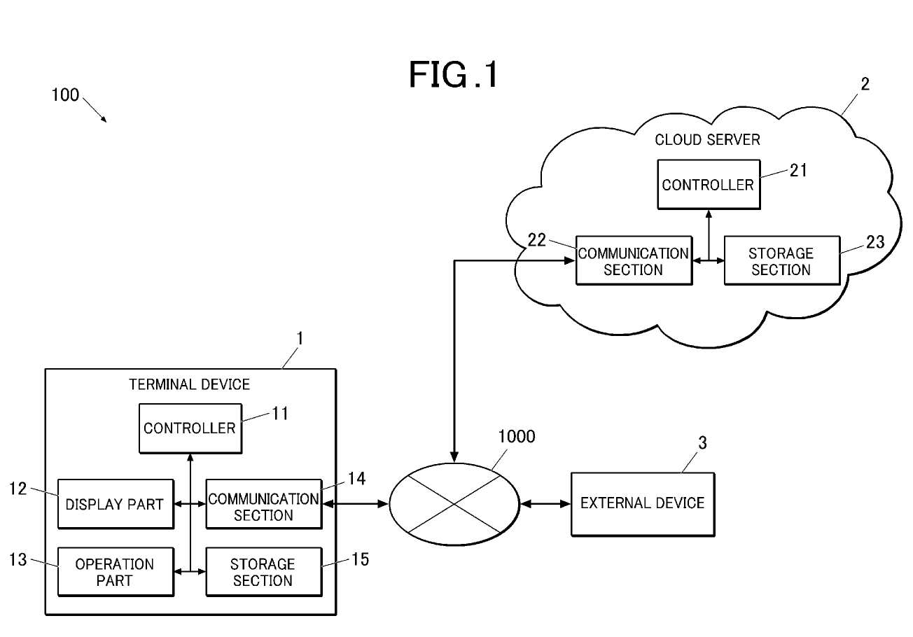

First, a configuration of an image generation supporting system 100 will be described with reference to FIG. 1. As illustrated in FIG. 1, the image generation supporting system 100 includes a terminal device 1, a cloud server 2, and an external device 3. The terminal device 1, the cloud server 2, and the external device 3 transmit and receive information via a communication network 1000.

The terminal device 1 is an apparatus for supporting image generation by a user such as a salesperson of a printing company or a customer thereof.

Specifically, the terminal device 1 displays a generated image generated by the cloud server 2 based on text data (first text data), reference image data, and fidelity input by the user, and accepts various operations on the generated image by the user.

Here, the reference image data is image data used as a reference in image generation. The fidelity is a degree of referring to the reference image data in the image generation. More specifically, when a layout and aspect ratio in the reference image data is regarded as important, the fidelity is increased. On the other hand, when importance is attached to contents (hue, sense of season, cultural background, depth, etc.) of input text data, the fidelity is low. As an index of the fidelity, for example, one of five levels may be selected, or a parameter value (0 to 100%) may be set.

The cloud server 2 is an image generation AI apparatus that generates second text data from the first text data, the reference image data, and the fidelity by using a text generation AI and that generates the generated image from the second text data by using the image generation AI.

Here, the second text data is a so-called prompt. Therefore, the cloud server 2 also has a function as an image generation supporting device.

The cloud server 2 may be an on-premise device, or the image generation supporting device and the image generation AI device may be configured as separate devices.

The external device 3 is a device that allows a designer to display a generated image or the like.

The communication network 1000 is a local area network (LAN), a wide area network (WAN), the Internet, or the like.

### Terminal Device 1

Next, a configuration of the terminal device 1 will be described with reference to FIG. 1. As illustrated in FIG. 1, the terminal device 1 includes a controller 11, a display part 12, an operation part 13, a communication section 14, and a storage section 15.

The controller 11 includes a central processing unit (CPU) and a random-access memory (RAM). The CPU of the controller 11 reads various programs stored in the storage section 15, deploys the programs in the RAM, executes various processes in accordance with the deployed programs, and controls the operation of each unit of the terminal device 1.

The display part 12 includes a monitor such as a liquid crystal display (LCD) and displays various screens and the like in accordance with instructions of display signals input from the controller 11.

The operation part 13 includes a keyboard having cursor keys, number input keys, various function keys, and the like, a pointing device such as a mouse, a touch screen layered on the surface of the display part 12, and the like. The operation part 13 is operable by an operator. The operation part 13 outputs various signals to the controller 11 based on operations performed by the operator.

The communication section 14 can transmit and receive various signals and various data to and from other devices and the like connected via the communication network 1000.

The storage section 15 includes a nonvolatile semiconductor memory, a hard disk, or the like, and stores various programs to be executed by the controller 11, parameters required for execution of the programs, various data, and the like.

### Cloud Server 2

Next, a configuration of the cloud server 2 will be described with reference to FIG. 1. As illustrated in FIG. 1, the cloud server 2 includes a controller 21 (hardware processor), a communication section 22, and a storage section 23.

The controller 21 includes a CPU, a RAM, and the like. The CPU of the controller 21 reads various programs stored in the storage section 23, deploys the programs in the RAM, executes various processes in accordance with the deployed programs, and controls the operation of each component of the cloud server 2.

The controller 21 generates the second text data from the first text data, the reference image data, and the fidelity by using the text generation AI, and generates the image from the second text data by using the image generation AI. Here, examples of the image generation AI include Stable Diffusion, DALL E2, Midjourney, starryai, Dream by WOMBO, and the like. Examples of the text generation AI include ChatGPT, Bard, Gemini, and Bloom.

The controller 21 functions as a first acquisition section that acquires the reference image data.

The controller 21 functions as a prompt generation section that generates the second text data as a prompt for causing the generation AI to generate the image based on the aspect ratio of the reference image data.

As a prompt generation section, the controller 21 may generate the second text data as the prompt that causes the generation AI to generate the image also based on the layout of the reference image data.

The controller 21 functions as a second acquisition section that acquires the text data.

As the prompt generation section, the controller 21 may generate the prompt for causing the generation AI to generate the image based on the text data and the aspect ratio of the reference image data.

The controller 21 functions as a third acquisition section that acquires the fidelity.

As the prompt generation section, the controller 21 may generate the prompt for causing the generation AI to generate the image based on the text data, the aspect ratio of the reference image data, and the fidelity.

The communication section 22 can transmit and receive various signals and various data to and from other devices and the like connected via the communication network 1000.

The storage section 23 includes a nonvolatile semiconductor memory, a hard disk, or the like, and stores various programs to be executed by the controller 21, parameters required for execution of the programs, various data, and the like.

### Image Generation Supporting Process

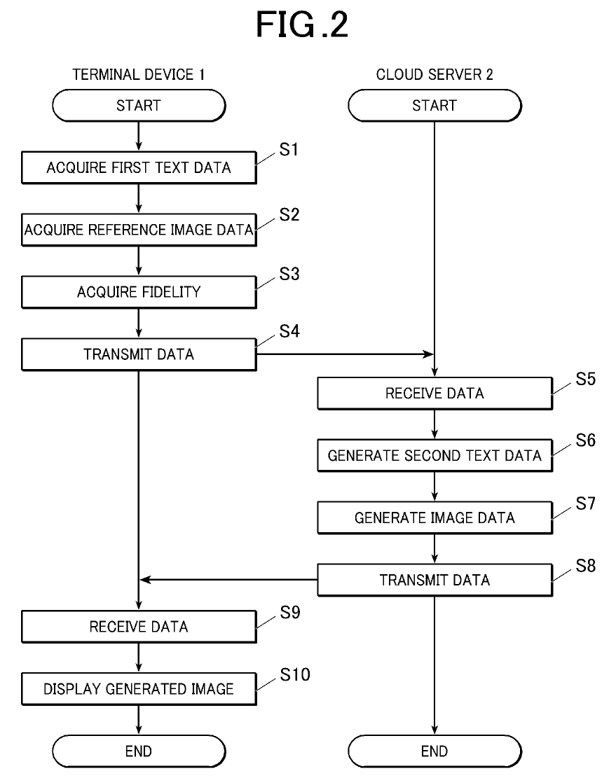

Next, the image generation supporting processing will be described with reference to the flow illustrated in FIG. 2.

The image generation supporting process is a process of supporting the user when the image generation is performed based on the first text data, the reference image data, and the fidelity input by the user such as the salesperson of the printing company or the customer thereof.

Although omitted in the flow illustrated in FIG. 2, the generated image data is eventually transmitted to the designer's terminal (external device 3).

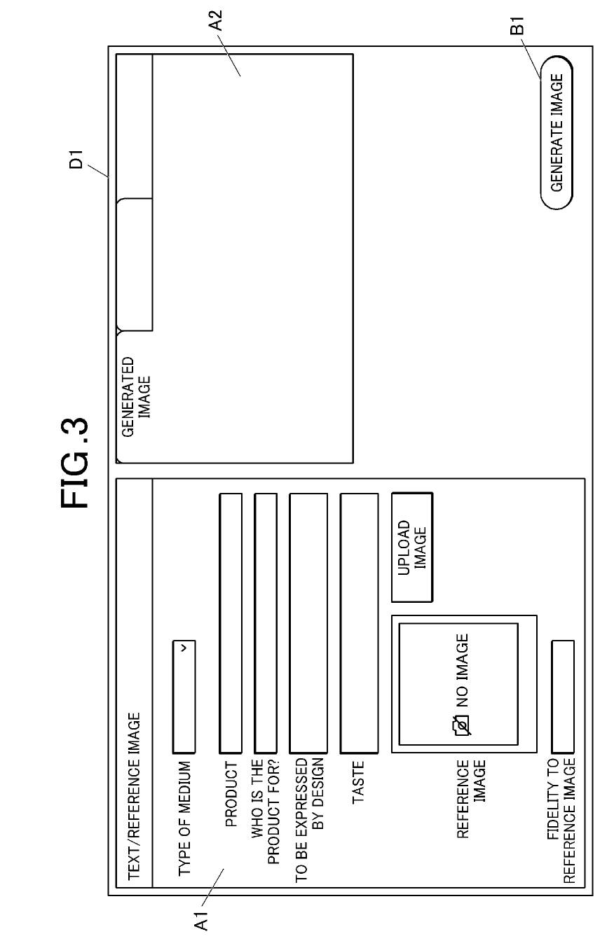

It is assumed that an image generation supporting screen D1 illustrated in FIG. 3 is initially displayed on the display part 12.

Here, the image generation supporting screen D1 illustrated in FIG. 3 will be described.

A region A1 is a region in which the user inputs the first text data, the reference image data, and the fidelity.

In the region A1, the first text data includes a type of medium, a product, a target person of the product, design contents, and a style.

In the region A1, the reference image data is uploaded by pressing an upload image button.

In the region A1, the fidelity is, for example, numerically input.

The region A2 is the region for displaying the generated image data whose image is generated by the cloud server 2.

The button B1 is a button for causing the cloud server 2 to generate the image.

First, the user inputs the first text data using the operation part 13. The controller 11 acquires the first text data (step S1).

Next, the user inputs the reference image data using the operation part 13. The controller 11 acquires the reference image data (step S2).

Next, the user inputs the fidelity by using the operation part 13. The controller 11 acquires the fidelity (step S3).

Next, the user presses the button B1 using the operation part 13. The controller 11 transmits the first text data, the reference image data, and the fidelity to the cloud server 2 via the communication section 14 (step S4).

Next, the controller 21 receives the first text data, the reference image data, and the fidelity via the communication section 22 (step S5; first acquiring step, second acquiring step, third acquiring step).

Next, the controller 21 generates the second text data based on the first text data, the reference image data and the fidelity (step S6; prompt generation section).

At this time, the controller 21 extracts the aspect ratio of the reference image data and includes the extracted aspect ratio in the second text data as the prompt.

Further, based on the fidelity, the controller 21 causes the second text data to include, as the prompt, content indicating which of the prompt generated from the first text data and the prompt generated from the reference image data is to be accurately used for image generation.

Further, the controller 21 may extract layout information from the reference image data and include the extracted layout information in the second text data as the prompt.

Next, the controller 21 generates the image by the generation AI based on the second text data (step S7; image generation step). The image data that is generated is defined as the generated image data.

Next, the controller 21 transmits the generated image data to the terminal device 1 via the communication section 22 (step S8).

Next, the controller 11 receives and acquires the generated image data via the communication section 14 (step S9).

Next, the controller 11 allows the display part 12 to display the generated image (step S10), and ends the image generation supporting process.

In this way, the user himself/herself does not have to set the aspect ratio for the prompt, and thus can easily generate a desired image. Furthermore, the user does not have to set, in the prompt, how accurately the reference image data is to be used for the image generation, and thus can easily generate the desired image.

### Example

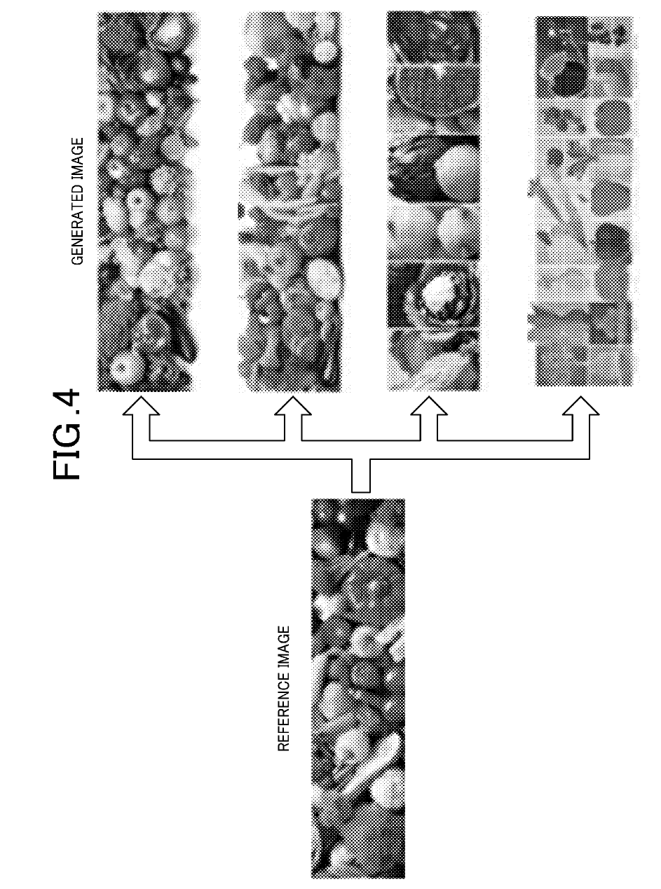

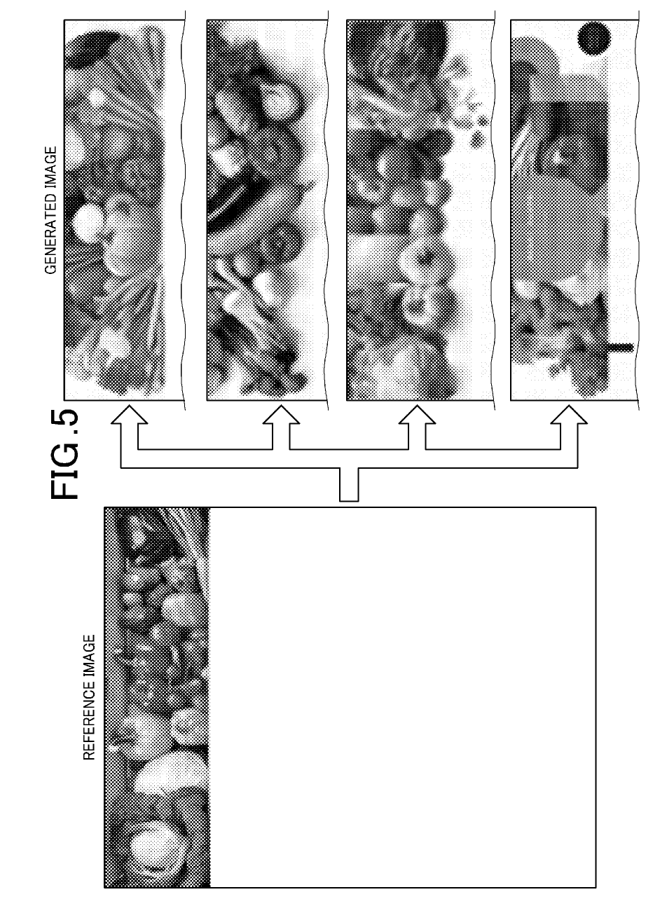

Examples of the reference image and the generated image will be described with reference to FIGS. 4 and 5.

FIG. 4 is an image diagram for generating the image based on the aspect ratio of the reference image data. The aspect ratio of the generated image is generated to be substantially the same as the aspect ratio of the reference image.

FIG. 5 is the conceptual diagram for generating the image based on the aspect ratio and the layout of the reference image data. The aspect ratio and the layout of the generated image are generated so as to be substantially the same as the aspect ratio and the layout of the reference image.

The reason why the above are substantially the same is due to the image generation by the generation AI. Since the images are generated by the generation AI, they are not necessarily matched with each other, and there is a slight deviation.

### Others

In the image generation supporting process described above, steps S1 to S3 have all been executed, but the present disclosure is not limited to this example.

For example, step S1 may not necessarily be performed. In this case, the second text data is generated as the prompt based on only the reference image data.

In addition, for example, step S3 may not necessarily be executed. In this case, the fidelity will not be set in the prompt in step S6 and step S7.

Although the image generation supporting process has been described above with the terminal device 1 and the cloud server 2 as separate devices, the terminal device 1 may be provided with various functions of the cloud server 2 so that the image generation supporting process is executed in the terminal device 1.

In this case, the processing content of each step is the same as each step of the image generation supporting process, but transmission and reception of data between the terminal device 1 and the cloud server 2 are not necessary. For example, the controller 11 does not receive data via the network 1000, but the controller 11 acquires the data directly.

### Effect

As described above, the program causes the computer to function as the first acquisition section (controller 21) that acquires the reference image data, and the prompt generation section (controller 21) that generates the prompt for causing the generation AI to generate the image based on the aspect ratio of the reference image data.

Therefore, it is possible to efficiently generate the image with the arbitrary aspect ratio.

The image generation supporting device (cloud server 2) includes the first acquisition section (controller 21) to acquire the reference image data and the prompt generation section (controller 21) to generate the prompt to cause the generation AI to generate the image based on the aspect ratio of the reference image data.

Therefore, it is possible to efficiently generate the image with the arbitrary aspect ratio.

The image generation supporting system 100 is the image generation supporting system including the image generation supporting device (cloud server 2), the image generation AI device (cloud server 2), and the terminal device 1. The image generation supporting device includes a first acquisition section (controller 21) acquiring the reference image data from the terminal device, and a prompt generation section (controller 21) generating the prompt to cause the generation AI to generate the image based on the aspect ratio of the reference image data. The image generation AI device includes the image generation section (controller 21) generating the image based on the prompt generated by the prompt generation section. The terminal device includes the display part 12 displaying the image generated by the image generation section.

Therefore, it is possible to efficiently generate the image with the arbitrary aspect ratio.

The image generation supporting method is the image generation supporting method executed by the image generation supporting system 100 and includes the first acquiring step (step S5) of acquiring the reference image data, the prompt generating step (step S6) of generating the prompt for causing the generation AI to generate the image based on the aspect ratio of the reference image data, and the image generating step (step S7) of generating the image based on the generated prompt.

Therefore, it is possible to efficiently generate the image with the arbitrary aspect ratio.

Hereinabove, the present disclosure has been specifically described with reference to the embodiment, but it is clear that the present disclosure is not limited to the above-described embodiment and can be appropriately modified without departing from the scope thereof.

For example, in the above description, an example in which a hard disk, a semiconductor nonvolatile memory, or the like is used as a computer-readable medium of the program according to the present disclosure has been disclosed, but the present disclosure is not limited to this example. As other computer-readable recording media, portable recording media such as CD-ROMs can be applied.

The detailed configuration and the detailed operation of each component can be appropriately changed without departing from the scope of the present disclosure.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. A non-transitory computer readable storage medium storing a program that causes a hardware processor of a computer to perform,
acquiring reference image data; and
generating a prompt that causes a generation AI to generate an image based on an aspect ratio of the reference image data.

2. The storage medium according to claim 1, wherein the hardware processor generates the prompt that causes the generation AI to generate the image based on a layout of the reference image data.

3. The storage medium according to claim 1, wherein,
the hardware processor acquires text data, and
the hardware processor generates the prompt that causes the generation AI to generate the image based on the text data and the aspect ratio of the reference image data.

4. The storage medium according to claim 3, wherein,
the hardware processor acquires fidelity,
the hardware processor generates the prompt that causes the generation AI to generate the image based on the text data, the aspect ratio of the reference image data, and the fidelity, and
the fidelity is a degree indicating which between the text data and the aspect ratio of the reference image data is to be accurately used for generating the image.

5. An image generation supporting device comprising:
a hardware processor,
wherein the hardware processor is configured to perform,
acquiring reference image data, and
generating a prompt that causes a generation AI to generate an image based on an aspect ratio of the reference image data.

6. An image generation supporting method executed by an image generation supporting system, the method comprising:
acquiring reference image data;
generating a prompt that causes a generation AI to generate an image based on an aspect ratio of the reference image data; and
generating the image based on the generated prompt.
